(19) United States
(12) Patent Application Publication
(10) Pub. No.: US 2025/0040508 A1
(43) Pub. Date: Feb. 6, 2025

(54) INDOOR PET TOILET SYSTEM

(71) Applicant: Milton Goff, Little River, SC (US)

(72) Inventor: Milton Goff, Little River, SC (US)

(21) Appl. No.: 18/228,747

(22) Filed: Aug. 1, 2023

(51) Int. Cl. A01K 1/01

(52) U.S. Cl. CPC A01K 1/011; A01K 1/0121

(57) ABSTRACT

An indoor pet toilet system has an elevated platform having a vertical wall extension along the rear, a drain opening through the top surface of the platform, a water source connection, a sewer drain connection, and a motion activated and timer controlled flushing mechanism in fluid communication with a water source.

### I. RELATED APPLICATIONS

There are no currently pending applications anywhere in the world.

### II. FIELD OF THE INVENTION

The present application discloses and describes a system for disposing of pet excretions via a toilet or sanitation system installable indoors or outdoors.

### III. Background

A number of sanitation systems have been attempted, including for indoor use with house pets and the like. A non-exhaustive review reveals that some of the following attempts are of interest:

U.S. Patent Publication No. 2008/0178817 A1, published in the name of Brewer;

U.S. Patent Publication No. 2017/0245459 A1, published in the name of Halliday;

U.S. Patent Publication No. 2009/0255477 A1, published in the name of Fournier et al.;

U.S. Patent Publication No. 2008/0245309 A1, published in the name of Markley;

U.S. Patent Publication No. 2007/0289541 A1, published in the name of Giardina;

U.S. Patent Publication No. 2006/0249090 A1, published in the name of Ahad;

U.S. Pat. No. 7,121,228 B1, issued in the name of Klauber;

U.S. Pat. No. 6,857,391 B1, issued in the name of Gantt;

U.S. Pat. No. 4,729,342, issued in the name of Loctin;

U.S. Pat. No. 3,835,812, issued in the name of Edwards; and

Chinese Patent No. CN110839535A, published in the name of Wáng Yi.

Accordingly, there is a need for an improved indoor or outdoor pet toilet or sanitation system.

This application presents claims and embodiments that fulfill a need or needs not yet satisfied by the products, apparatuses, inventions, and methods previously or presently available. In particular, the claims and embodiments disclosed herein describe a pet toilet system, wherein the system comprises an elevated platform having a sloped-surface, a vertical wall extension along a rear, and a drain opening through a top surface of the platform; a water source connection; a sewer drain connection; a plurality of water-jets delivering water under pressure across the sloped-surface of the platform; a toilet assembly; and a motion activated and timer controlled flushing mechanism in fluid communication with the water source, wherein the indoor pet toilet system of the present invention providing unanticipated and nonobvious combination of features distinguished from the products, devices, apparatuses, inventions, and methods preexisting in the art. The applicant is unaware of any product, method, disclosure or reference that discloses the features of the claims and embodiments disclosed and taught herein.

### IV. SUMMARY

It is envisioned that the embodiments disclosed herein provide a pet toilet system comprising an elevated platform having a vertical wall extension along the rear, a drain opening through the top surface of the platform, a water source connection and a sewer drain connection as well as a purge system (motion activated and timer controlled) flushing mechanism in fluid communication with a water source.

In accordance with one embodiment, an interior enclosure comprising an elevated platform having a sloped-surface and a drain opening, the platform defined by an upstanding lower interior sidewall comprising a plurality of water-jets delivering water under pressure across the sloped-surface of the platform and an upstanding upper interior sidewall upwardly depending from the platform and having an interval defined by a left lateral margin and a right lateral margin defining the lateral edges of the upper interior sidewall, the interval providing ingress and egress into and out of the platform. The system also includes a toilet assembly comprising a bowl, a water-flushing tank, and an outlet drain-pipe, the tank in fluid communication with the bowl, and the bowl and outlet drain-pipe in fluid communication with the drain opening.

The system also includes an exterior enclosure comprising an upstanding exterior sidewall and an exterior top wall disposed along the top of the upstanding exterior sidewall, the exterior sidewall and top wall removable and defining a first space formed between the exterior sidewall and the interior sidewall housing the tank and the outlet drain-pipe.

In accordance with another embodiment, an interior enclosure comprising an elevated platform having a sloped-surface and a drain opening, the platform defined by an upstanding lower interior sidewall comprising a plurality of water-jets delivering water under pressure across the sloped-surface of the platform and an upstanding upper interior sidewall upwardly depending from the platform and having an interval defined by a left lateral margin and a right lateral margin defining the lateral edges of the upper interior sidewall, the interval providing ingress and egress into and out of the platform.

The system also includes an outlet drain-pipe in fluid communication with the drain opening.

The system includes an also exterior enclosure comprising an upstanding exterior sidewall and an exterior top wall disposed along the top of the upstanding exterior sidewall, the exterior sidewall and top wall removable and defining a first space formed between the exterior sidewall and the interior sidewall housing the tank and the outlet drain-pipe.

Each embodiment may include variable controls for adjusting motion, timing, and/or water pressure utilizing an interface with variable controls.

Each embodiment may also include removable steps for abutting to the edge of the enclosures and the platform to facilitate ingress and egress.

### V. BRIEF DESCRIPTION OF THE DRAWING(S)

FIG. 1 is a side view of the system;

FIG. 2 is a plan view of the system;

FIG. 3 is front-side view of the system;

FIG. 4 a schematic of the variable control interface;

FIG. 5 is an alternate embodiment of the system using a gravitation evacuation mechanism; and

FIG. 5a is partial, longitudinal sectional view of the outlet drain-pipe depicting the drain access port thereof and the removable cap plug, in accordance to one embodiment of the present invention.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this that a particular feature, specification refers to the fact structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

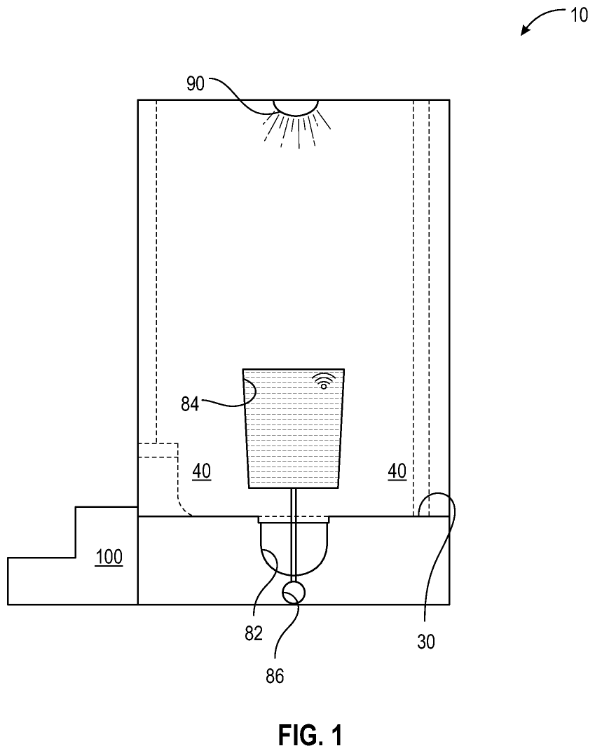

In accordance with the drawings illustrating at least one embodiment of a pet toilet system, the pet toilet system being adapted and configured for installation either as an indoor system or an outdoor system, as generally depicted in FIG. 1 through FIG. 5a. Consistent with FIG. 1, an indoor pet toilet system 10 comprising an elevated platform 30 having a vertical wall extension along the rear, a drain opening 38 through the top surface of the platform, a water source connection 84 and a sewer drain connection 82, 86, as well as a purge system 90 (motion activated and timer controlled) flushing mechanism in fluid communication with a water source.

In one embodiment, the system 10 an interior enclosure 20, an exterior enclosure 50, and a platform 30 having a sloped-surface 36 with a drain opening 38 disposed within the enclosures (20, 50), and further including a toilet assembly 80 and automatic purge system 90.

More particularly, in such an embodiment, the system 10 interior enclosure 20 comprises an elevated platform 30 having a sloped-surface 36 and a drain opening 38. The platform 30 is defined by an upstanding lower interior sidewall 32 comprising a plurality of water-jets 40 delivering water under pressure across the sloped-surface 36 of the platform 30 and an upstanding upper interior sidewall 34 upwardly depending from the platform 30 and having an interval 42 defined by a left lateral margin 41 and a right lateral margin 43 defining the lateral edges of the upper interior sidewall 34. The interval 42 providing ingress and egress into and out of the platform 30.

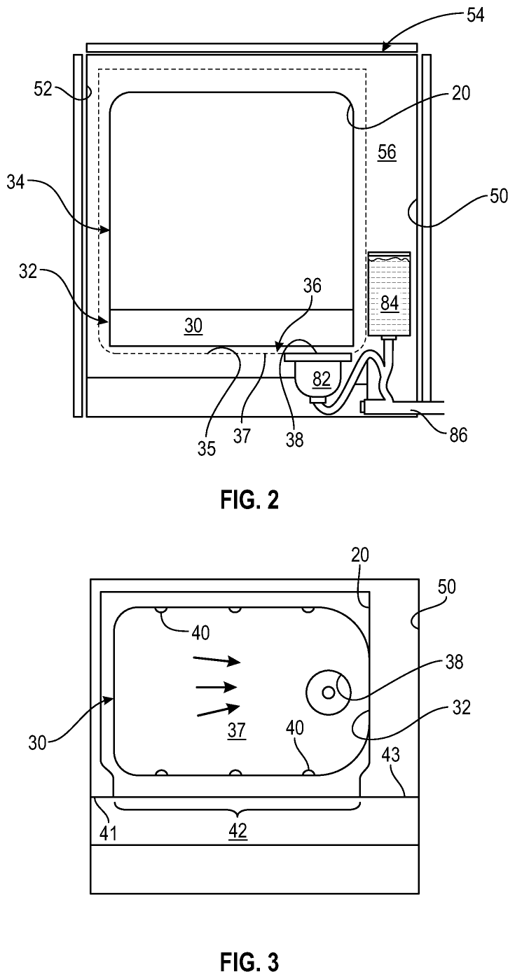

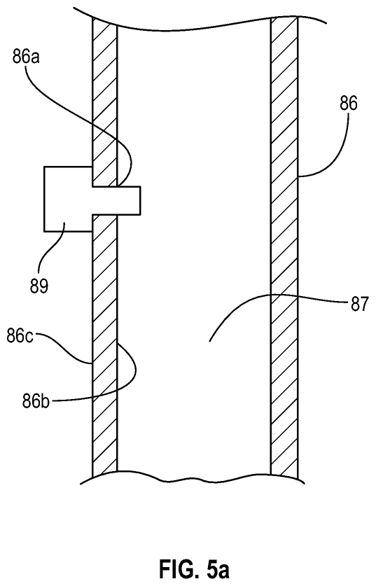

The system 10 includes a toilet assembly 80 comprising a bowl 82, a water-flushing tank 84, and an outlet drain-pipe 86. The outlet drain-pipe 86 is characterized as being unitary in design. The tank 84 is in fluid communication with the bowl 82, and the bowl 82 and outlet drain-pipe 86 are in fluid communication with the drain opening 38. The outlet drain-pipe 86 is connected to a sewage system SS, such as a municipal sewer system or a septic tank, in accordance with applicable slope and plumbing requirements. As best illustrated in FIGS. 2 and 5, the outlet drain-pipe 86 comprises a U-shaped trap 88 formed between the drain opening 38 and a distal end of the outlet drain-pipe 86. As previously described, the outlet drain-pipe 86 is characterized as being unitary in design, and is in fluid communication the drain opening 38. Thus, the trap 88 of outlet drain-pipe 86 is in fluid communication with the drain opening 38. The U-shaped trap 88 functions to trap backflow (unwanted flow of water in the reverse direction) and/or noxious sewer gases that may emanate from the sewer system SS, and thus prevents the backflow and/or the sewer gases from entering the area that the pet toilet system 10 is installed.

Referring now more particularly to FIGS. 5 and 5a, positioned intermediate the drain opening 38 and the trap 88, a drain access port 86a is defined through an external circumferential sidewall 86c of the outlet drain-pipe 86 providing direct open passage into a hollow interior 87 of outlet drain-pipe 86. The drain access port 86a provides a hole through which a liquid, such as water, or other cleaning solution may be injected into the hollow interior 87 of outlet drain-pipe 86 to remove clogged matter and other debris clinging to the interior sidewall 86b of outlet drain-pipe 86. A removable cap plug 89 closes the drain access port 86a in a sealed, airtight fashion.

In reference to FIGS. 1-3, the system 10 further includes an exterior enclosure 50 comprises an upstanding exterior sidewall 52 and an exterior top wall 54 disposed along the top of the upstanding exterior sidewall 52. The exterior sidewall 52 and top wall 54 are each separately removable. The exterior sidewall 52 and the interior sidewalls 32, 34 define a first space 56 formed therebetween for housing the tank 84 and the outlet drain-pipe 86.

Within this embodiment, and more particularly, the platform 30 has a sloped-surface 36 that includes a top surface 35 and a bottom surface 37 in mutually opposed orientation. The bottom surface 37 is elevated above a sub-floor surface of a structure (such as a residential apartment or house, or a commercial building), and defines a second space 58 housing the bowl 82 in fluid communication with the drain opening 38.

The platform 30 may also include upstanding lower interior sidewall 32 and an upstanding upper interior sidewall 34, the upper interior sidewall 34 upwardly depending from the lower interior sidewall 32 to form a generally uniform sidewall perimeter for the interior enclosure 20.

It is envisioned that the lower interior sidewall 32 comprises a single continuous sidewall having an ovoid or rounded-corner rectangular shape defining the platform. It is also envisioned that the lower interior sidewall comprises a plurality of sidewalls, wherein the plurality of sidewalls includes four upstanding interior sidewalls defining the platform 30.

It is also envisioned that the upper interior sidewall 34 comprises a single continuous sidewall having an ovoid or rounded shape or form with an interval 42 defining the platform 30. It is also envisioned that the upper interior sidewall 34 comprises a plurality of sidewalls, wherein the plurality of sidewalls includes three upstanding upper interior sidewalls and forming an interval 42 by omitting a fourth upstanding upper interior sidewall.

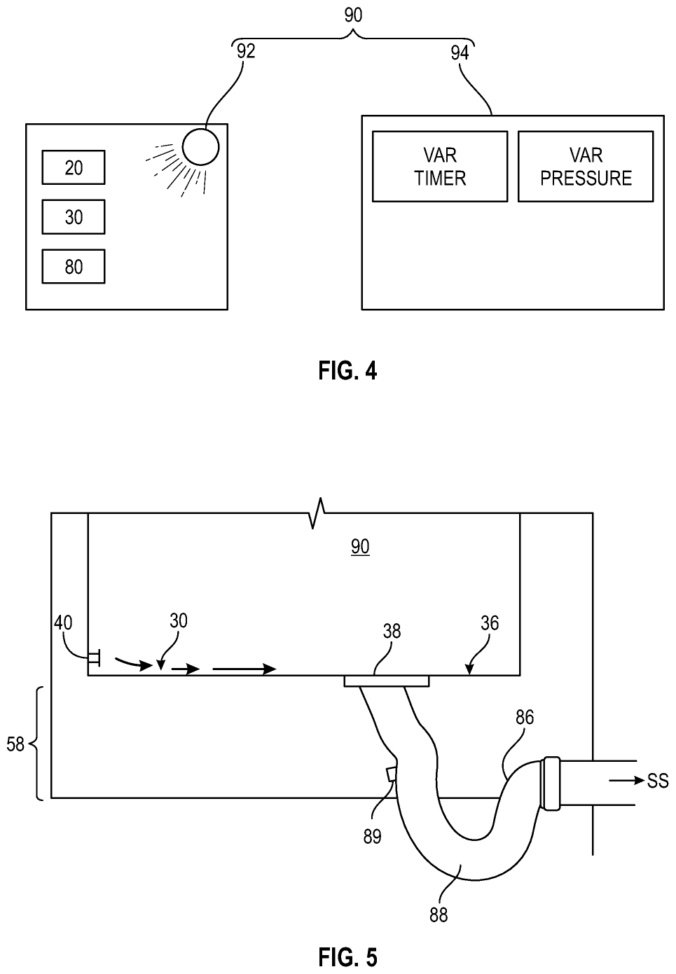

As part of such an embodiment, the system 10 may further comprise an automatic purge system 90 (illustrated in FIGS. 4 and 5) for moving excretions from the platform 30 through the drain opening 38 and outlet drain-pipe 86. The automatic purge system 90 further comprises a motion sensor 92 and a variable control interface 94. It is envisioned in one embodiment that the automatic purge system 90 actuates the tank 82 to evacuate excretions from the bowl 84 and through the outlet drain-pipe 86. In such an embodiment, the motion sensor 92 and the variable control interface 94 are interoperable for detecting a pet entering the platform 30 and activating the plurality of water-jets 40 for evacuating excretions on a predetermined time-delay.

It is further envisioned that the variable control interface 94 comprises variable timer controls for time-delay activation. In one embodiment, the time-delayed activation results in synchronous activation of each one of the plurality of the water-jets, and may be time-delayed in a specific, select synchronous manner. Alternatively, it is envisioned that the time-delayed activation may be asynchronous, and in particular may be specific and selectively asynchronous in activating the plurality of water-jets. Moreover, the variable control interface may further comprise variable water-pressure controls for the water-jets to optimize water waste.

The system 10 may further comprise removable steps 100 that abut the exterior enclosure 50 and the interior enclosure 20. The removable steps 100 may be oriented with the interval 42 formed between the lateral margins of the upstanding upper interior sidewalls.

In another embodiment, consistent with FIG. 5, the automatic purge and toilet assembly is replaced by a drain and drain outlet using gravitational means to orient the drain outlet to move excretion downline. It is envisioned that the drain outlet might be tied to existing forced-flush systems within a home or structure.

For purposes of this disclosure, and as previously described, the pet toilet system 10, as a combination of interdependent elements, may be installed as an indoor system or an outdoor system.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. An indoor pet toilet system comprising:
an elevated platform having a vertical wall extension along a rear, a drain opening through a top surface of the platform;
a water source connection;
a sewer drain connection; and
a motion activated and timer controlled flushing mechanism in fluid communication with a water source.

2. A pet toilet system comprising:
an interior enclosure comprising an elevated platform having a sloped-surface and a drain opening, the platform defined by an upstanding lower interior sidewall comprising a plurality of water-jets delivering water under pressure across the sloped-surface of the platform and an upstanding upper interior sidewall upwardly depending from the platform and having an interval defined by a left lateral margin and a right lateral margin defining the lateral edges of the upper interior sidewall, the interval providing ingress and egress into and out of the platform;
a toilet assembly comprising a bowl, a water-flushing tank, and an outlet drain-pipe, the tank in fluid communication with the bowl, and the bowl and outlet drain-pipe in fluid communication with the drain opening; and
an exterior enclosure comprising an upstanding exterior sidewall and an exterior top wall disposed along the top of the upstanding exterior sidewall, the exterior sidewall and top wall removable and defining a first space formed between the exterior sidewall and the interior sidewall housing the tank and the outlet drain-pipe.

3. The system of claim 2 further comprising an automatic purge system for moving excretions from the platform through the drain-opening and outlet drain-pipe.

4. The system of claim 3, wherein the automatic purge system further comprises a motion sensor and a variable control interface.

5. The system of claim 4, wherein the automatic purge system actuates the tank to evacuate excretions from the bowl and through the outlet drain-pipe.

6. The system of claim 5, wherein the motion sensor and the variable control interface are interoperable for detecting a pet entering the platform and activating the plurality of water-jets for evacuating excretions on a predetermined time-delay.

7. The system of claim 6, wherein the variable control interface comprises variable timer controls for time-delay activation.

8. The system of claim 7, wherein the time-delayed activation results in synchronous activation of each one of the plurality of the water-jets.

9. The system of claim 8, wherein the time-delayed activation results in select synchronous activation of the plurality of water-jets.

10. The system of claim 7, wherein the time-delayed activation results in asynchronous activation of each one of the plurality of the water-jets.

11. The system of claim 10, wherein the time-delayed activation results in select asynchronous activation of the plurality of water-jets.

12. The system of claim 5, wherein the variable control interface further comprises variable water-pressure controls for the water-jets to optimize water waste.

13. The system of claim 2, wherein the sloped-surface of the elevated platform comprises a top surface and a bottom surface in mutually opposed orientation, the bottom surface elevated above a sub-floor surface of a structure and defining a second space housing the bowl in fluid communication with the drain-opening.

14. The system of claim 2, wherein the exterior sidewall comprises three upstanding exterior sidewalls.

15. The system of claim 2, wherein the interior sidewall comprises four upstanding interior sidewalls.

16. The system of claim 2 further comprising removable steps.

17. The system of claim 14, wherein the removable steps abut the exterior enclosure and the interior enclosure, the removable steps oriented with the interval formed between the lateral margins of the upstanding upper interior sidewalls.

18. A pet toilet system comprising:
an interior enclosure comprising an elevated platform having a sloped-surface and a drain opening, the platform defined by an upstanding lower interior sidewall comprising a plurality of water-jets delivering water under pressure across the sloped-surface of the platform and an upstanding upper interior sidewall upwardly depending from the platform and having an interval defined by a left lateral margin and a right lateral margin defining the lateral edges of the upper interior sidewall, the interval providing ingress and egress into and out of the platform;
an outlet drain-pipe in fluid communication with the drain opening; and
an exterior enclosure comprising an upstanding exterior sidewall and an exterior top wall disposed along the top of the upstanding exterior sidewall, the exterior sidewall and top wall removable and defining a first space formed between the exterior sidewall and the interior sidewall housing the tank and the outlet drain-pipe.

19. The system of claim 18 further comprising an automatic purge system for moving excretions from the platform through the drain-opening and the outlet drain-pipe.

20. The system of claim 19, wherein the automatic purge system further comprises a motion sensor and a variable control interface.
